(19) United States
(12) Patent Application Publication
(10) Pub. No.: US 2026/0343438 A1
(43) Pub. Date: Oct. 29, 2026

(54) TIMING ADVANCE ESTABLISHMENT DURING INITIAL ACCESS FOR MULTIPLE TRANSMISSION AND RECEPTION POINT SYSTEMS

(71) Applicant: QUALCOMM Incorporated, San Diego, CA (US)

(72) Inventors: Xiaoxia ZHANG, San Diego, CA (US); Tao LUO, San Diego, CA (US); Junyi LI, Greentown, PA (US); Jelena DAMNJANOVIC, Del Mar, CA (US); Mostafa KHOSHNEVISAN, San Diego, CA (US); Wooseok NAM, San Diego, CA (US); Sony AKKARAKARAN, Poway, CA (US); Navid ABEDINI, Basking Ridge, NJ (US); Jianghong LUO, Skillman, NJ (US); Qian ZHANG, Basking Ridge, NJ (US)

(21) Appl. No.: 19/191,360

(22) Filed: Apr. 28, 2025

(51) Int. Cl. H04W 52/50; H04L 5/00; H04W 74/0833

(52) U.S. Cl. CPC H04W 52/50; H04L 5/0048; H04W 74/0833

(57) ABSTRACT

This disclosure provides methods, components, devices and systems for timing advance establishment during initial access for multiple transmission and reception point (TRP) systems. For example, a user equipment (UE) may receive multiple synchronization signal blocks (SSBs) each corresponding to a respective TRP of multiple TRPs of a network. The UE may transmit, in an initial access procedure in accordance with receiving the multiple SSBs, one or more signals indicative of one or more timing advances (TAs), each of the one or more timing advances (TAs) corresponding to a TRP of at least a subset of the multiple TRPs. The UE may communicate with the network via the subset of the plurality of TRPs in accordance with the TAs corresponding to the subset of the plurality of TRPs. For example, the UE may perform multi-TRP communication with the network in accordance with the TAs.

### TECHNICAL FIELD

This disclosure relates generally to wireless communication, and more specifically to systems, devices, methods, and techniques associated with timing advance (TA) establishment during initial access for multiple transmission and reception point (multi-TRP) systems.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a set of multiple synchronization signal blocks (SSBs) each corresponding to a respective transmission and reception point (TRP) of a set of multiple TRPs of a network, transmitting, in an initial access procedure in accordance with receiving the set of multiple SSBs, one or more signals indicative of one or more timing advances (TAs), each of the one or more TAs corresponding to a TRP of at least a subset of the set of multiple TRPs, and communicating with the network via the subset of the set of multiple TRPs in accordance with the TAs corresponding to the subset of the set of multiple TRPs.

A UE for wireless communications is described. The UE may include a processing system that includes processor circuitry and memory circuitry that stores code. The processing system may be configured to cause the UE to receive a set of multiple SSBs each corresponding to a respective TRP of a set of multiple TRPs of a network, transmit, in an initial access procedure in accordance with receiving the set of multiple SSBs, one or more signals indicative of one or more TAs, each of the one or more TAs corresponding to a TRP of at least a subset of the set of multiple TRPs, and communicate with the network via the subset of the set of multiple TRPs in accordance with the TAs corresponding to the subset of the set of multiple TRPs.

Another UE for wireless communications is described. The UE may include means for receiving a set of multiple SSBs each corresponding to a respective TRP of a set of multiple TRPs of a network, means for transmitting, in an initial access procedure in accordance with receiving the set of multiple SSBs, one or more signals indicative of one or more TAs, each of the one or more TAs corresponding to a TRP of at least a subset of the set of multiple TRPs, and means for communicating with the network via the subset of the set of multiple TRPs in accordance with the TAs corresponding to the subset of the set of multiple TRPs.

A non-transitory computer-readable medium storing code for wireless communications is described. The code may include instructions executable by one or more processors (e.g., directly, indirectly, without pre-processing, after pre-processing) to receive a set of multiple SSBs each corresponding to a respective TRP of a set of multiple TRPs of a network, transmit, in an initial access procedure in accordance with receiving the set of multiple SSBs, one or more signals indicative of one or more TAs, each of the one or more TAs corresponding to a TRP of at least a subset of the set of multiple TRPs, and communicate with the network via the subset of the set of multiple TRPs in accordance with the TAs corresponding to the subset of the set of multiple TRPs.

In some examples of the method, UEs, and non-transitory computer-readable medium described herein, transmitting the one or more signals may include operations, features, means, or instructions for transmitting, based on a duration of receiving at least a subset of SSBs of the plurality of SSBs satisfying a threshold duration, a random access message that indicates the at least the subset of the plurality of TRPs, the at least the subset of SSBs corresponding to the at least the subset of the plurality of TRPs.

Some examples of the method, UEs, and non-transitory computer-readable medium described herein may further include operations, features, means, or instructions for receiving one or more second signals, different than the set of multiple SSBs, that trigger transmission of the one or more signals, the one or more signals including one or more physical random access channel (PRACH) signals, one or more sounding reference signals (SRSs), or a combination thereof and receiving, in response to transmitting the one or more signals, an indication of the one or more TAs.

In some examples of the method, UEs, and non-transitory computer-readable medium described herein, the one or more signals include a random access message of the initial access procedure that indicates the at least the subset of the set of multiple TRPs in response to receiving the set of multiple SSBs and the method, apparatuses, and non-transitory computer-readable medium may include further operations, features, means, or instructions for receiving, in response to transmitting the one or more signals, a random access response of the initial access procedure that indicates the one or more TAs.

In some examples of the method, UEs, and non-transitory computer-readable medium described herein, the one or more signals includes a first random access message of a first random access procedure corresponding to a first TRP and a second random access message of a second random access procedure corresponding to a second TRP of the set of multiple TRPs and the method, apparatuses, and non-transitory computer-readable medium may include further operations, features, means, or instructions for receiving a random access response that indicates to communicate with the network via the subset of the set of multiple TRPs in accordance with the one or more TAs, the one or more TAs based on transmitting the first random access message and the second random access message of the second random access procedure.

### BRIEF DESCRIPTION OF THE DRAWINGS

FIG. 1 shows an example of a wireless communication system.

FIG. 2 shows an example of a signaling configuration that supports timing advance (TA) establishment during initial access for multiple transmission and reception point (multi-TRP) systems.

FIG. 3-8 show examples of process flows that supports TA establishment during initial access for multi-TRP systems.

FIG. 9 shows a block diagram of a processing system that supports TA establishment during initial access for multi-TRP systems.

FIG. 10 shows a diagram of a system including a device that supports TA establishment during initial access for multi-TRP systems.

FIGS. 11 and 12 show flowcharts illustrating methods that support TA establishment during initial access for multi-TRP systems.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate with a network using multiple transmission and reception point (multi-TRP) communication. For example, a network may use multiple TRPs (e.g., network entities, antenna panels, antennas, radio units (RUs)) to communicate with a UE, and the TRPs may correspond to (e.g., be connected with, provide communications using) a common central unit (CU), distributed unit (DU), or a combination thereof. Multi-TRP communication may support higher data rates than single-TRP communication and may support energy saving for communication between a UE and a network. In some implementations, multi-TRP communication may be supported by a network with TRPs that may be in different locations. To synchronize communications across the TRPs, a UE may apply timing advances (TAs) to uplink transmissions. In some cases, to support multi-TRP communication, a UE in a connected state may communicate with a network to enable a multi-TRP communication scheme and may determine relevant TAs during or after enabling a multi-TRP communication scheme. For example, a UE and a network may be connected, and the UE may request, or the network may determine, to enable multi-TRP communication. However, enabling multi-TRP communication and determining TAs after a UE has entered a connected state with a network may occupy time, frequency, or processing resources, which could otherwise be used for other purposes. For example, a UE may be in an idle or disconnected state while performing an initial access procedure to join a network. Although the UE may benefit from multi-TRP communication during or after the initial access procedure, the network may not enable a multi-TRP communication scheme at the UE until after the UE has entered the connected state, which may also involve additional signaling overhead.

Aspects of the subject matter described in this disclosure relate to handling TAs for multi-TRP communication during an initial access procedure. For example, in some implementations, a UE may restrict or may be restricted from using TRPs that may have a timing difference greater than some threshold (e.g., a cyclic prefix) or may use TRPs that are grouped together, such as by location (e.g., as indicated in SSB co-location information), such that the multi-TRP communication may be possible without TAs (e.g., by the network entity, UE, or both performing location-based timing pre-compensation) or in accordance with a same TA for multiple TRPs (e.g., a TA corresponding to a primary TRP, a TA corresponding to the average TA between multiple TRPs, or another TA). In some other implementations, a UE and a network may communicate information about TAs during an initial access procedure. In some cases, a network may trigger transmission of physical random access channel (PRACH) messages or reference signals, during the initial access procedure, for determining TAs at the network, and may indicate the TAs as part of the initial access procedure. In some cases, a network and a UE may share information that may allow the TAs to be determined or derived at the network or the UE. In some cases, a UE may perform parallel random access procedures (e.g., initial access procedures) with multiple TRPs (e.g., a primary TRP and at least a secondary one TRP), and the random access messages sent during the parallel random access procedures may be used to determine TAs at a network, which may then be indicated to the UE.

Particular aspects of the subject matter described in this disclosure can be implemented to realize one or more of the following potential advantages. In some examples, by restricting TRPs for multi-TRP communication based on timing differences, the described techniques can be used to enable multi-TRP communication with reduced overhead and latency corresponding to determining TAs during or prior to multi-TRP communication. In some examples, by sharing information between a network and a UE to derive TAs, the described techniques can be used to implement multi-TRP communication with TAs for increased communication reliability and an improved utilization of processing capability of the UE, the network, or a combination thereof. In some examples, by triggering transmission of PRACH or reference signals during an initial access procedure while enabling multi-TRP communication, the described techniques can be used to efficiently determine TAs based on reference signals with minimal or reduced extra signaling. In some examples, by implementing parallel random access procedures with multiple TRPs, the described techniques can be used to determine TAs during an initial access procedure, leveraging existing types of signaling and procedures for determining TAs for primary TRPs, to improve communication reliability and enable multi-TRP communication.

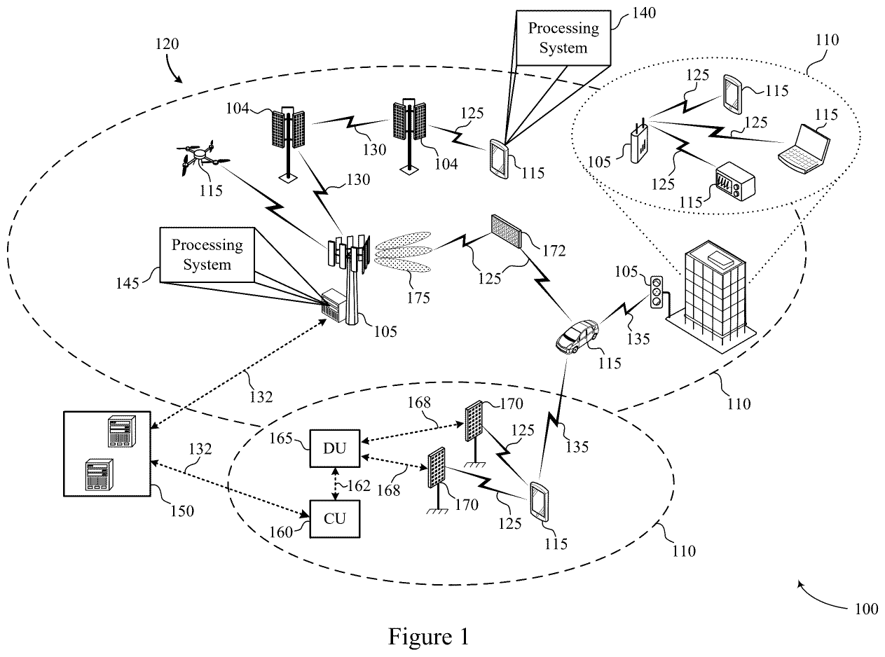

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR 1), between 425 MHz and 7.125 GHz), a mid-band (such as Frequency Range 3 ((FR3), between 7.125 GHz and 24.25 GHz), or an upper frequency band (such as Frequency Range 2 (FR 2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number. A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, SRSs that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval.

Devices of the wireless communication system 100 may be configured to support one or more aspects of the described techniques for TA establishment during initial access for multi-TRP systems. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support handling TAs for multi-TRP communication during an initial access procedure. For example, in some implementations, a UE 115 may restrict or may be restricted from using TRPs (e.g., network entities 105, RUs 170, antennas, antenna panels) that may have a timing difference greater than some threshold (e.g., a cyclic prefix) or may use TRPs that are grouped together, such as by location (e.g., as indicated in SSB co-location information), such that multi-TRP communication may be possible without TAs (e.g., by the network entity 105, UE 115, or both performing location-based timing pre-compensation) or in accordance with a same TA for multiple TRPs (e.g., a TA corresponding to a primary TRP, a TA corresponding to the average TA between multiple TRPs, or another TA). By restricting TRPs for multi-TRP communication based on timing differences, the described techniques can be used to enable multi-TRP communication with reduced overhead and latency corresponding to determining TAs during or prior to multi-TRP communication.

In some implementations, a UE 115 and a network (e.g., a RAN 120) may communicate information about TAs during an initial access procedure. By sharing information between a network and a UE 115 to derive TAs, the described techniques can be used to implement multi-TRP communication with TAs for increased communication reliability and an improved utilization of processing capability of the UE 115, the network, or a combination thereof. In some cases, a network may trigger transmission of PRACH messages or reference signals (e.g., sounding reference signals (SRSs)), during an initial access procedure, for determining TAs at the network, and may indicate the TAs as part of the initial access procedure. By triggering transmission of PRACH or reference signals during an initial access procedure while enabling multi-TRP communication, the described techniques can be used to efficiently determine TAs based on reference signals with minimal or reduced extra signaling. In some cases, a network and a UE 115 may share information that may allow TAs to be determined or derived at the network or the UE 115. In some cases, a UE 115 may perform parallel random access procedures (e.g., initial access procedures) with multiple TRPs (e.g., a primary TRP and at least a secondary TRP), and random access messages sent during the parallel random access procedures may be used to determine TAs at a network, which may be indicated to the UE 115. By implementing parallel random access procedures with multiple TRPs, the described techniques can be used to determine TAs during an initial access procedure, leveraging existing types of signaling and procedures for determining TAs for primary TRPs, to improve communication reliability and enable multi-TRP communication.

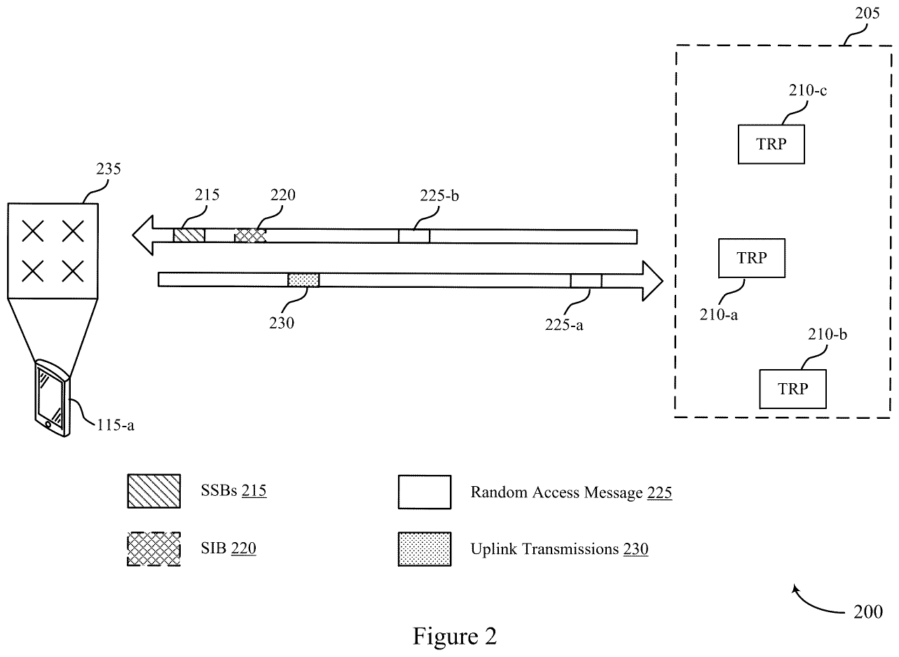

FIG. 2 shows an example of a signaling configuration 200 that supports TA establishment during initial access for multi-TRP systems. The signaling configuration 200 may implement, or be implemented by, aspects of the wireless communication system 100. For example, the signaling configuration 200 may include a network 205 (e.g., a RAN 120, a portion of a wireless communication system 100) including multiple TRPs 210 (e.g., TRPs 210-a, 210-b, 210-c) and one or more UEs 115, including at least the UE 115-a. The techniques described in the context of the signaling configuration 200 may support the network 205 and the UE 115-a establishing or determining, in (e.g., during, as part of, as a function of) an initial access procedure, one or more TAs for multi-TRP communication.

The network 205 may support wireless communication with the UE 115-a using a multi-TRP communication scheme, which may refer to communication between the UE 115-a and the network 205 using multiple TRPs 210. In some examples, a respective set of multiple TRPs 210 of the network 205 may be associated with a single network entity 105, such as TRPs 210 being respective antenna panels of a single network entity 105. Additionally, or alternatively, a single TRP 210 of the network 205 may correspond to a single network entity 105, such as a TRP 210 being an example of an RU 170. In some examples, multiples of such TRPs 210 (e.g., as multiple RUs 170) may correspond to a single CU 160, or one or more DUs 165, or a combination thereof. Thus, in accordance with these and other examples, multiple TRPs 210 of the network 205 may correspond to any quantity of one or more network entities 105. Using multiple TRPs 210 at the network 205 may enable multi-TRP (e.g., multi-panel, multiple network entity 105) transmission and reception at the network 205. In some implementations, the UE 115-a may also include multiple antennas or antenna panels 235. Such a configuration at the UE 115-a may allow the UE 115-a to enable multi-TRP communication schemes with the network 205 that may include simultaneous reception or transmission at the UE. Enabling a wireless device, such as the UE 115-a, to be served by multiple TRPs 210 may improve signal transmission and reception for the wireless device based on increased throughput.

Multi-TRP communication may implement space division multiplexing (SDM), frequency division multiplexing (FDM), time division multiplexing (TDM), and single frequency networks (SFNs). For example, TRPs 210 that implement SDM communication may utilize multiple spatial channels for simultaneous data transmission. Additionally, or alternatively, TRPs 210 that implement FDM communication may utilize multiple frequencies within a bandwidth for simultaneous data transmission. Additionally, or alternatively, TRPs 210 that implement TDM communication may send independent signals on a common channel at different times. Additionally, or alternatively, TRPs 210 that implement an SFN may each transmit the same information on the same frequency at the same time. In some cases, single-TRP communication may be considered a case of multi-TRP communication where one TRP 210 may be selected for some communications. In some implementations, multi-TRP communication may be intra-frequency specific. In some other implementations, multi-TRP operation may be extended across frequency layers (e.g., inter-frequency).

In some implementations, multi-TRP communication may be enabled after a UE 115 is configured in a connected mode (e.g., having established a communication link with the network 205, such as a communication link 125). In some other implementations, multi-TRP communication may be enabled during an initial access procedure. For example, the UE 115-a may receive SSBs 215 from multiple TRPs 210 corresponding to (e.g., associated with, indicating, for configuring communication with) the network 205. In some examples, each TRP 210 may transmit an SSB 215, which may be received by the UE 115-a. In some implementations, the network 205 may transmit (e.g., from one or more of the TRPs 210), via an SIB 220, assistance information for reporting on the SSBs 215 for multi-TRP communication. The UE 115-a may report information about the TRPs 210 (e.g., signal strength, cells, frequencies), based on receiving the SSBs 215 from the TRPs 210, to the network 205 in a first random access message 225-a for an initial access procedure. The network 205 may use the reported information to implement or indicate multi-TRP communication in a second random access message 225-b for the initial access procedure. Such techniques may support indicating aspects of a multi-TRP communication scheme as part of a communication establishment between the network 205 and the UE 115-a, such as an establishment of a communication link 125 that supports a multi-TRP communication scheme.

In some implementations, the UE 115-a may transmit, after enabling multi-TRP communication (e.g., a multi-TRP communication scheme) during the initial access procedure, uplink transmissions 230 to the network 205. In some cases, the uplink transmissions 230 may be transmitted according to an uplink multi-TRP communication scheme, such that the UE 115-a may transmit the uplink transmissions 230 to different TRPs 210 of the network 205. For example, the UE 115-a may transmit an uplink transmission 230 to the TRP 210-a and a second uplink transmission 230 to the TRP 210-b (e.g., the UE 115-a may target reception by different TRPs 210). In some cases, there may be some propagation delay based on transmitting to different TRPs 210 and additionally, or alternatively, non-perfect synchronization among TRPs 210. For example, the TRPs 210 of the network 205 may not be co-located, or may be located some distance apart that may result in a delay (e.g., propagation delay, propagation delay difference) between an uplink transmission 230 reaching a first TRP 210 and an uplink transmission 230 reaching a second TRP 210, even if the uplink transmissions 230 are transmitted at the same time.

In some examples, the UE 115-a may implement different uplink TAs to support uplink transmissions 230 being received at the TRPs 210 of the network 205 simultaneously or in accordance with timing corresponding to the multi-TRP communication schemes. For example, the UE 115-a may implement a TA, such that an uplink transmission 230 to a further TRP 210 may be transmitted before an uplink transmission 230 for a closer TRP 210. For example, the UE 115-a may transmit an uplink transmission 230 to the TRP 210-b some time, according to a first TA, prior to transmitting an uplink transmission 230 to the TRP 210-a, which may be closer to the UE 115-a.

The UE 115-a implementing a multi-TRP communication scheme may rely on determining uplink TAs for transmitting messages to different TRPs 210 of the network 205. During an initial access procedure, for example, a TA for a primary TRP 210 may be determined and indicated in a random access message 225 (e.g., random access response) for the initial access procedure. However, other TRPs 210 (e.g., secondary TRPs 210) used for multi-TRP communication may not be known. For the UE 115-a to enable a multi-TRP communication scheme during an initial access procedure, the UE 115-a may implement signaling to determine TAs for the secondary TRPs 210 during the initial access procedure or may restrict multi-TRP communication to TRPs 210 that may not use TAs for communication (e.g., co-located TRPs 210).

For example, in some implementations, the UE 115-a may restrict or may be restricted from using TRPs 210 that may have a timing difference greater than some threshold (e.g., a cyclic prefix) or may use TRPs 210 that are grouped together, such as by location (e.g., as indicated in SSB co-location information), such that the multi-TRP communication may be possible without TAs (e.g., by the network entity 105-a, UE 115-a, or both performing location-based timing pre-compensation) or in accordance with a same TA for multiple TRPs 210 (e.g., a TA corresponding to a primary TRP 210, a TA corresponding to the average TA between multiple TRPs 210, or another TA). By restricting the TRPs 210 for multi-TRP communication based on timing differences, the described techniques can be used to enable multi-TRP communication with reduced overhead and latency corresponding to determining TAs during or prior to multi-TRP communication.

In some implementations, the UE 115-a and the network 205 may communicate information about TAs during an initial access procedure. In some cases, the network 205 and the UE 115-a may share information that support TAs being determined or derived at the network 205 or the UE 115-a. In some cases, the network 205 may trigger transmission of PRACH messages or reference signals, during an initial access procedure, for determining TAs at the network 205, and may indicate the TAs as part of the initial access procedure. In some cases, the UE 115-a may perform parallel random access procedures (e.g., initial access procedures) with multiple TRPs 210 (e.g., a primary TRP 210 and at least one secondary TRP 210), and random access messages sent during the parallel random access procedures may be used to determine TAs at the network 205, which may then be indicated to the UE 115-a. By communicating information between the network 205 and the UE 115-a to determine (e.g., derive, calculate, establish, acquire) TAs, the described techniques can be used to implement multi-TRP communication with TAs for increased communication reliability and an improved utilization of the processing capability of the UE 115-a, the network 205, or a combination thereof.

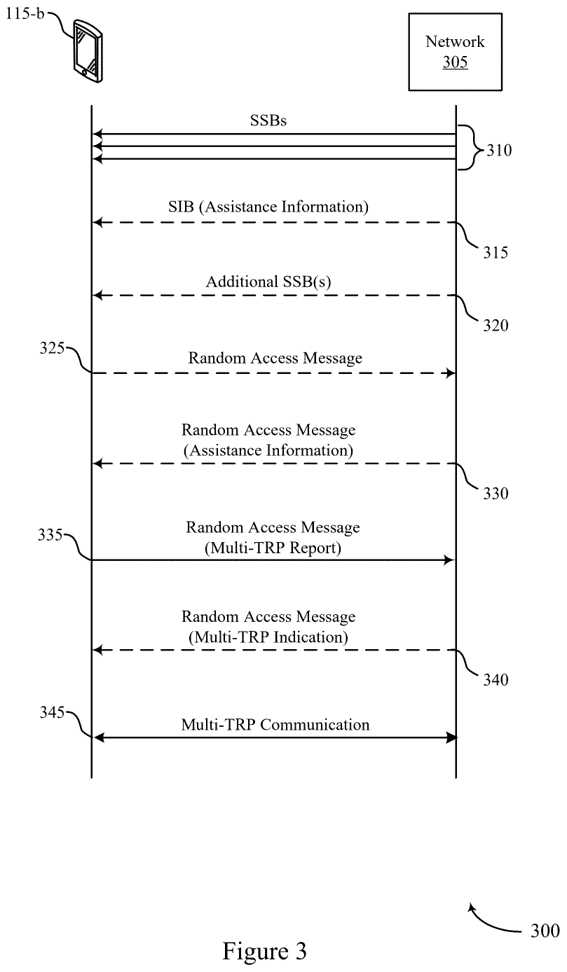

FIG. 3 shows an example of a process flow 300 that supports TA establishment during initial access for multi-TRP systems. The process flow 300 may implement, or be implemented by, aspects of the wireless communication system 100 and the signaling configuration 200. For example, the process flow 300 may include one or more UEs 115, including at least the UE 115-b. The techniques described in the context of the process flow 300 may support a network 305 (e.g., an example of a network 205) and UE 115-b restricting TRPs 210 for multi-TRP communication, or deriving, at the network 305 or the UE 115-b and during an initial access procedure, one or more TAs for multi-TRP communication.

The network 305 may include multiple TRPs 210. For example, the network 305 may include multiple TRPs 210 (e.g., RUs 170, antenna panels) that may share a common CU 160, a common DU 165, or a combination thereof. In some cases, the multiple TRPs 210 may correspond to a multi-TRP communication scheme that may support communication with the network 305 via one or more of the multiple TRPs 210. In some examples, the multi-TRP communication scheme may include SDM, FDM, TDM, a SFN, or a combination thereof. The UE 115-b may communicate with the network 305 for an initial access procedure to enable a multi-TRP communication scheme.

At 310, the network 305 may transmit (e.g., from a set of multiple TRPs 210) multiple SSBs (e.g., SSBs 215), each corresponding to a respective TRP 210 of multiple TRPs 210 of the network 305, which may be received by the UE 115-b. The SSBs may be sent from different TRPs 210 of the network 305. For example, a first TRP 210 may transmit a first SSB of the SSBs at 310, and a second TRP 210 may transmit a second SSB of the SSBs at 310. In some implementations, the UE 115-b may measure the received SSBs (e.g., signal strength, timing). The measurements at the UE 115-b, corresponding to the SSBs, may indicate information about the respective TRPs 210. In some cases, the UE 115-b may report information about the measurements of the SSBs to the network 305 during the initial access procedure (e.g., multi-TRP report). For example, the UE 115-b may report a signal strength for each SSB in a random access message (e.g., at 335). The information for the SSBs, which may be across different cells, frequencies, or a combination thereof, may indicate or include information related to different TRPs 210 of the network 305. Additionally, or alternatively, information about the SSBs 310 may indicate or include information related to antenna panels at the UE 115-b.

The network 305 may use the information reported by the UE 115-b to aid in enabling a multi-TRP communication scheme during the initial access procedure, such as via the random access message (e.g., at 340, in a random access response, multi-TRP indication, multi-TRP enablement indication). At 345, the UE 115-b and the network 305 may communicate according to the multi-TRP communication scheme, in accordance with a multi-TRP indication at 340. For example, the UE 115-b may communicate with the network 305 via a subset of multiple TRPs 210 of the network 305.

In some cases, at 315, the network 305 may transmit (e.g., using one or more TRPs 210) one or more SIBs (e.g., SIBs 220), which may be received by the UE 115-b. The SIBs may include assistance information for the UE 115-b to use for determining TRPs 210 to include in a multi-TRP report (e.g., at 335) and for formatting or configuring the multi-TRP report. For example, at 315, the UE 315-b may receive assistance information corresponding to the multiple TRPs 210 (e.g., corresponding to the multiple SSBs at 310), and transmission of a random access message (e.g., one or more signals, at 335) may be based on the assistance information. Additionally, or alternatively, the network 305 may transmit one or more additional SSBs that the UE 115-b may measure.

In some cases, an initial access procedure may be a four-step random access procedure. For a four-step random access procedure, the UE 115-b may transmit a random access message at 325 (e.g., a Msg1 of the four-step random access procedure), which may include preamble information. At 330, the UE 115-b may receive a random access message in response to the random access message at 325 (e.g., a Msg2 of the four-step random access procedure). In some examples, the random access message at 330 may include assistance information or additional assistance information, similar to the SIB at 315. In some examples, the assistance information may be related to the one or more additional SSBs at 320. For a four-step random access procedure, the random access message at 335 may be a third message of the random access procedure (e.g., a Msg3 of the four-step random access procedure) and the random access message at 340 may be a fourth message of the random access procedure (e.g., a Msg4 of the four-step random access procedure). In some other cases, an initial access procedure may be a two-step random access procedure, and the UE 115-b may not receive or transmit random access messages at 325 or 330. A random access message at 335 may be the first message of the two-step random access procedure (e.g., a MsgA of the two-step random access procedure), and the random access message at 340 may be the second message of the two-step random access procedure (e.g., a MsgB of the two-step random access procedure).

In some implementations, to communicate according to the multi-TRP communication scheme, as at 345, the UE 115-b may rely on TAs corresponding to the multiple TRPs 210 of the network 305 for TRPs 210 that may not be synchronized or may not be co-located. In some cases, the UE 115-b and the network 305 may restrict the TRPs 210 included in the multi-TRP communication scheme such that the difference in TAs among the TRPs 210 may not be significant or may be below a threshold. For example, the UE 115-b and the network 305 may selectively enable TRPs 210 for uplink multi-TRP communication with a constrained TA difference. In some examples, the threshold TA difference (e.g., threshold duration) may be based on a duration of a cyclic prefix.

In some cases, the constrained TA difference may be determined based on timing of downlink messages from the different TRPs 210 of the network 305. For example, the UE 115-b may receive multiple SSBs at 310. The UE 115-b may estimate the difference in the timing (e.g., timing delta) across the SSBs and, based on the detected difference in timing across the SSBs, the UE 115-b may decide which TRPs 210 to include in a multi-TRP report (e.g., at 335) for inclusion in the multi-TRP communication scheme. For example, at 335, the UE 115-b may transmit, during the initial access procedure in accordance with receiving the multiple SSBs at 310, one or more signals (e.g., random access message, multi-TRP report) indicative of one or more TAs corresponding to a TRP 210 of at least a subset of the multiple TRPs 210 of the network 305, which may be received by the network 305. In some cases, to transmit the one or more signals at 335, the UE 115-b may transmit, based on a duration of receiving at least a subset of SSBs of the multiple SSBs satisfying a threshold duration, a random access message that indicates (e.g., one or more signals) that indicates the at least the subset of the multiple TRPs 210, the at least the subset of SSBs corresponding to the at least the subset of the plurality of TRPs. For example, the UE 115-b may report the TRPs 210 that satisfy the threshold difference in timing across the SSBs (e.g., difference in reception time, threshold duration) as TRPs 210 for use in a multi-TRP communication scheme.

In some examples, the network 305 may provide an indication of a threshold timing difference between SSBs (e.g., the threshold duration). The UE 115-b may receive the indication of the threshold duration. For example, the network 305 may transmit (e.g., using one or more TRPs 210) an indication of the threshold duration via the SIB at 315, the random access message at 330 for a four-step random access procedure (e.g., Msg2), via control signaling, via a standalone message, or a combination thereof. The UE 115-b may enable uplink multi-TRP communication if a difference in timing across associated SSBs is below the threshold timing difference.

Additionally, or alternatively, the SSBs at 310 may be grouped based on location or other grouping information. For example, the network 305 may signal SSB co-location information, which may indicate that a group of SSBs belong to a TRP 210, a panel of a TRP 210, or a combination thereof. Co-located TRPs 210 may not use different TAs or may have negligible difference in TAs between the different TRPs 210. The UE 115-b may allow uplink multi-TRP transmission for TRPs 210 corresponding to SSBs in the same group without determining (deriving, calculating, receiving) TAs for each TRP 210.

At 345, the UE 115-b may communicate with the network 305 via the subset of the multiple TRPs 210 in accordance with the TAs corresponding to the subset of the multiple TRPs 210. For example, the UE 115-b may communicate with the network 305 via the TRPs 210 corresponding to SSBs corresponding to timing differences below the threshold duration, TRPs 210 grouped together based on the SSB colocation information, or a combination thereof. In some cases, communicating with the network 305 via the subset of the multiple TRPs 210 may include the UE 115-b transmitting a feedback message that indicates that the initial access procedure was successful (e.g., via an uplink multi-TRP communication scheme using restricted TRPs 210, using one TA for all TRPs 210). In some examples, by restricting the TRPs 210 for multi-TRP communication based on timing differences, co-location information, or a combination thereof, the described techniques can be used to enable multi-TRP communication with reduced overhead and latency corresponding to determining TAs during or prior to multi-TRP communication.

In some implementations, the network 305 or the UE 115-b may provide information to the other entity to support TA acquisition for secondary TRPs 210 of the network 305. In some cases, the TA acquisition or derivation of the TAs may be performed at the network 305. For example, the network 305 may determine TAs for uplink transmissions from the UE 115-b to the different TRPs 210 of the network 305. In some examples, the network 305 may, based on the SSBs reported at 335 along with other information (e.g., digital twin information), derive a TA for a secondary TRP 210. The network 305 may signal the additional TA information (e.g., the TAs for the secondary TRPs 210) in a random access message (e.g., Msg4, MsgB) responsive to the random access message (e.g., multi-TRP report) at 335. For example, at 335, the UE 115-b may transmit, in (e.g., during, as part of, as a function of) the initial access procedure and in accordance with receiving the multiple SSBs at 310, one or more signals indicative of one or more TAs, each of the one or more TAs corresponding to a TRP 210 of at least a subset of the multiple TRPs 210, which may be received by the network 305. In some examples, the one or more signals may include a random access message of the initial access procedure that indicates the at least the subset of the multiple TRPs 210 in response to receiving the multiple SSBs at 310 (e.g., a multi-TRP report). At 340, the network 305 may transmit (e.g., using one or more TRPs 210, in response to receiving the random access message at 335) a random access response (e.g., random access message, Msg4, MsgB) of the initial access procedure that indicates the one or more TAs, which may be received by the UE 115-b (e.g., in response to transmitting the random access message at 335).

In some cases, the network 305 may derive the TA based on some assistance from the UE 115-b. For example, if the TRPs 210 of the network 305 are synchronized or if the TRPs 210 have information about a timing offset (e.g., both downlink and uplink) between the TRPs 210, the uplink TA may be determined based on a downlink timing difference between the TRPs 210. The network 305 may indicate (e.g., via the SIB at 315, via the random access message at 330, or via a standalone message, using one or more TRPs 210) for the UE 115-b to report the downlink timing difference (e.g., based on receiving the SSBs at 310) in the random access message at 335 (e.g., Msg33, MsgA, multi-TRP report). For example, the network 305 may transmit, and the UE 115-b may receive, a request to transmit, using the random access message at 335, timing information based on the multiple SSBs at 310, and the one or more TAs may be based on transmitting the timing information. The network 305 may derive the TA based on the reported downlink timing difference and the known TRP timing offset. The network 305 may then indicate the TA, or the TA difference for TRPs 210, to the UE 115-b via the random access message at 340 (e.g., Msg4, MsgB).

In some cases, the UE 115-b may derive the TA based on some assistance from the network 305. For example, the network 305 may indicate uplink and downlink timing differences across the TRPs 210 to the UE 115-b (e.g., via the SIB at 315, the random access message at 340, or a combination thereof), which may be received by the UE 115-b. Based on the signaled uplink and downlink timing difference, along with a measured received timing difference at the UE 115-b (e.g., based on the SSBs at 310), the UE 115-b may autonomously determine the TA for a secondary TRP 210.

At 345, the UE 115-b may communicate with the network 305 via the subset of the multiple TRPs 210 in accordance with the TAs corresponding to the subset of the multiple TRPs 210. For example, the UE 115-b may communicate with the network 305 via an uplink multi-TRP in accordance with the network-derived or UE-derived TAs. In some examples, communicating with the network 305 in accordance with the TAs may include the UE 115-b transmitting a feedback message that indicates that the initial access procedure was successful. The UE 115-b may transmit the feedback message to subset of the multiple TRPs 210 of the network 305 in accordance with the respective TAs corresponding to the subset of the multiple TRPs 210. In some examples, by sharing information between the network 305 and UE 115-b to derive the TAs, the described techniques can be used to implement multi-TRP communication with TAs for increased communication reliability and an improved utilization of the processing capability of the UE 115-b, the network 305, or a combination thereof.

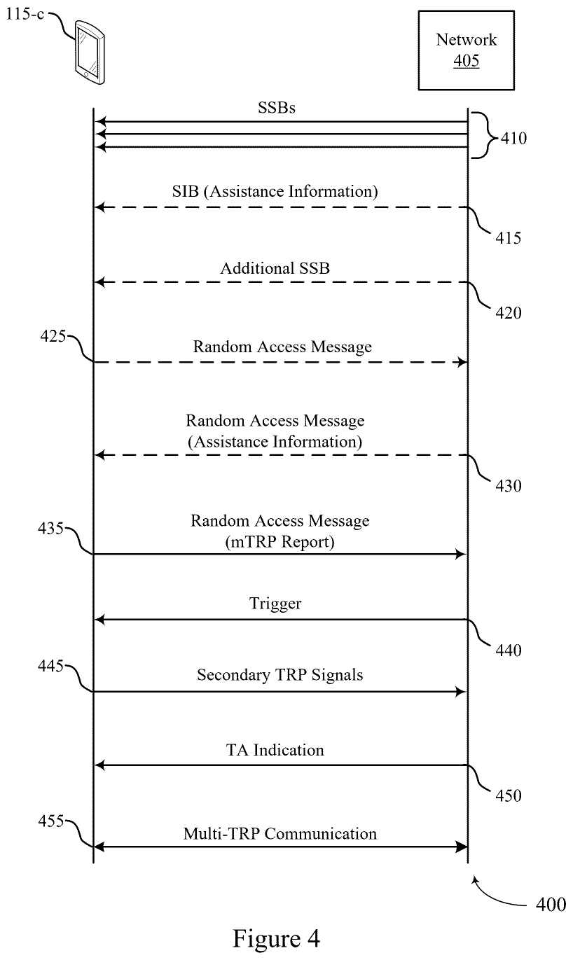

FIG. 4 shows an example of a process flow 400 that supports TA establishment during initial access for multi-TRP systems. The process flow 400 may implement, or be implemented by, aspects of the wireless communication system 100, the signaling configuration 200, and the process flow 300. For example, the process flow 400 may include one or more UEs 115, including at least the UE 115-c. The techniques described in the context of the process flow 400 may support a UE 115-c to transmit random access messages or reference signals to secondary TRPs of a network 405 (e.g., an example of a network 205) to determine uplink TAs for multi-TRP communication with the network 405.

The UE 115-c and the network 405 may communicate to enable multi-TRP communication during an initial access procedure. Process flow 400 may be an example of such a process. At least some of the techniques described with reference to process flow 300 may also apply to process flow 400. For example, at 410, the network 405 may transmit (e.g., using multiple TRPs 210) multiple SSBs, each corresponding to a respective TRP 210 of multiple TRPs 210 of the network 405, which may be received by the UE 115-c. In some cases, at 415, the UE 115-c may receive assistance information corresponding to the multiple TRPs 210, and transmission of a random access message (e.g., one or more signals, at 335) may be based on the assistance information. The UE 115-c may receive the assistance information via a SIB. In some cases, at 420, the network 405 may transmit (e.g., using one or more TRPs 210) one or more additional SSBs that the UE 115-b may measure.

In some implementations, the UE 115-c may measure the received SSBs (e.g., signal strength, timing). In some cases, the UE 115-c may report information about the measurements of the SSBs, corresponding to the TRPs 210 of the network 405, to the network 405 during the initial access procedure (e.g., a multi-TRP report). For example, the UE 115-c may report signal strength for each SSB in a random access message (e.g., at 435). The network 405 may use the information reported by the UE 115-c for enabling a multi-TRP communication scheme during the initial access procedure, such as via a random access response (e.g., random access message) for the random access message (e.g., at 435).

In some cases, the initial access procedure may be a four-step random access procedure. For a four-step random access procedure. the UE 115-c may transmit a random access message at 425 (e.g., a Msg1 of the four-step random access procedure), which may include preamble information. At 430, the UE 115-b may receive a random access message in response to the random access message at 425 (e.g., a Msg2 of the four-step random access procedure). In some examples, the random access message at 430 may include assistance information or additional assistance information, similar to the SIB at 415. In some examples, the assistance information may be related to the one or more additional SSBs at 420. For a four-step random access procedure, the random access message at 435 may be a third message of the random access procedure (e.g., a Msg3of the four-step random access procedure). In some other cases, the initial access procedure may be a two-step random access procedure, and the UE 115-b may not receive or transmit random access messages at 425 or 430. The random access message at 435 may be the first message of the two-step random access procedure (e.g., a MsgA of the two-step random access procedure).

In some wireless communication systems, an additional on-demand UE transmission may be triggered or requested by the network 405 to acquire TA information for secondary TRPs 210 during the initial access procedure. For example, the network 405 may trigger transmission of signals to secondary TRPs 210 of the network 405 (e.g., PRACH messages, SRSs, other reference signals) from the UE 115-c. In some implementations, the UE 115-c may transmit a random access message including a multi-TRP report at 435 (e.g., a Msg3 for a four-step random access procedure, a MsgA for a two-step random access procedure). At 440, the network 405 may transmit, responsive to the random access message at 435, a trigger for the UE 115-c to transmit one or more reference signals (e.g., PRACH messages, SRSs, other reference signals) at 445. The network 405 may use the signals of the received at secondary TRPs 210 at 445 to determine TAs for the secondary TRPs 210 of the network 405 and may indicate the TAs to UE 115-c at 450.

In some cases, the trigger at 440 may occur prior to enabling multi-TRP communication via a random access message. For example, the trigger at 440 may be a standalone message that triggers transmission of the reference signals at 445. After successful reception of the multi-TRP report (e.g., a Msg3, a MsgA) by the network 405 at 435, the network 405 may trigger the reference signals prior to sending a responsive random access message (e.g., a Msg4 for a four-step random access procedure, a MsgB for a two-step random access procedure). The network 405 may include the TA indication in a random access message at 450. For example, additional differential TA information, with reference to the primary TRP 210, may be signaled from the network 405 to the UE 115-c at 450 via a random access message (e.g., a Msg4 for a four-step random access procedure, a MsgB for a two-step random access procedure). The TA indication may be included in a DCI portion of the random access message or a payload (e.g., as part of the shared data, via a PDSCH) of the random access message. After receiving the random access message with the TA indication 450, the UE 115-c may communicate, at 455, with the network 405 according to a multi-TRP communication scheme and using the TAs. For example, the UE 115-c may transmit a feedback message (e.g., an ACK message) indicating successful reception of the random access message at 450 using an uplink multi-TRP communication scheme in accordance with the TAs indicated at 450.

In some other cases, the trigger at 440 may be sent via a random access message. For example, the network 405 may trigger transmission of the reference signals at 440 via a random access message (e.g., a Msg4 for a four-step random access procedure, a MsgB for a two-step random access procedure) responsive to the random access message at 435. In some cases, for a trigger at 440 sent via a random access message (e.g., a Msg4, a MsgB), the random access message at 440 may include an identifier for the UE 115-c. If multiple UEs 115 receive the random access message at 440, only the UEs 115 with an identifier included in the random access message may transmit the reference signals at 445. In some cases, after receiving the random access message and trigger at 440, the UE 115-c may transmit a feedback message indicating successful reception of the random access message at 440. In some examples, the UE 115-c may transmit the feedback message prior to receiving the TA indication at 450 and may not be able to enable an uplink multi-TRP communication scheme for the feedback message without receiving the TA indication at 450. In some examples, the UE 115-c may delay transmission of the feedback message until reception of the TA indication at 450 and may then transmit the feedback message using an uplink multi-TRP communication scheme (e.g., as part of multi-TRP communication at 455).

For example, in some implementations, at 440, the UE 115-c may receive one or more second signals, different than the multiple SSBs at 410, that may trigger transmission of one or more signals (e.g., at 445). At 445, the UE 115-b may transmit, in the initial access procedure and in accordance with receiving the multiple SSBs at 410, the one or more signals indicative of one or more TAs, each of the one or more TAs corresponding to a TRP 210 of at least a subset of the multiple TRPs 210 for the network 405. At 450, the UE 115-c may receive, in response to transmitting the one or more signals, an indication of the one or more TAs.

In some cases, the initial access procedure may be a two-step random access procedure. A second message (e.g., a MsgB) of the two step random access procedure may include the one or more second signals. For example, at 440, the network 405 may transmit the second message of the two step random access procedure to trigger the secondary TRP signals at 445. Additionally, or alternatively, the second message of the two-step random access procedure may include the indication of the one or more TAs (e.g., at 450). For example, at 440, the network 405 may transmit a separate trigger message, and at 450, the network 405 may transmit the second message of the two step random access procedure, which may indicate the one or more TAs.

In some other cases, the initial access procedure may be a four-step random access procedure. A fourth message (e.g., a Msg4) of the four-step random access procedure may include the one or more second signals. For example, at 440, the network 405 may transmit the fourth message of the four-step random access procedure to trigger the secondary TRP signals at 445. Additionally, or alternatively, the second message of the four-step random access procedure may include the indication of the one or more TAs (e.g., at 450). For example, at 440, the network 405 may transmit a separate trigger message, and at 450, the network 405 may transmit the fourth message of the four-step random access procedure, which may indicate the one or more TAs.

In some implementations, the indicated one or more TAs at 450 may be absolute TAs for a respective TRP 210. In some other implementations, the indicated one or more TAs at 450 may be differential TAs, indicating a difference between a TA for the secondary TRP 210 and the primary TRP 210 (e.g., a differential TA with reference to the primary TRP 210). In some cases, the reference signals at 445 transmitted to the secondary TRPs 210 of the network 405 may be transmitted using on-demand resources for a random access occasion (RO), SRS, or other reference signal, which may reduce energy consumption and overhead for scheduling the secondary TRP signals at 445.

At 455, the UE 115-c may communicate with the network 405 via the subset of the multiple TRPs in accordance with the TAs corresponding to the subset of the multiple TRPs. For example, the UE 115-c may transmit a feedback message that may indicate that the initial access procedure was successful. The UE 115-c may transmit the feedback message to one or more TRPs 210 of the network 405 in accordance with the one or more TAs established during the initial access procedure (e.g., via the secondary TRP signals). In some examples, by triggering transmission of the secondary TRP signals (e.g., PRACH signals, reference signals) during an initial access procedure while enabling multi-TRP communication, the described techniques can be used to efficiently determine TAs based on reference signals with minimal or reduced extra signaling.

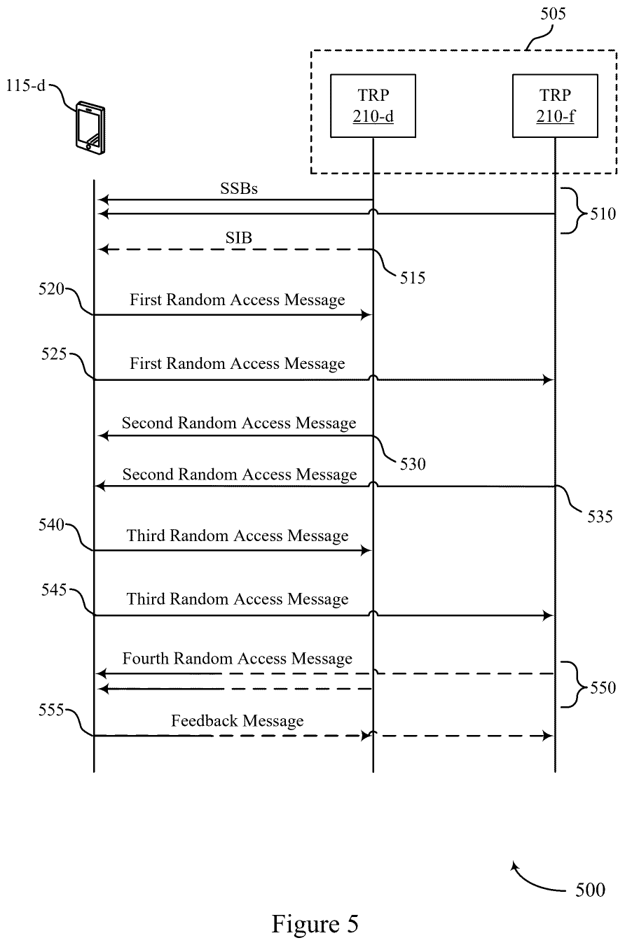

FIG. 5 shows an example of a process flow 500 that supports TA establishment during initial access for multi-TRP systems. The process flow 500 may implement, or be implemented by, aspects of the wireless communication system 100, the signaling configuration 200, and the process flows 300 and 400. For example, the process flow 500 may include one or more UEs 115, including at least the UE 115-d. The techniques described in the context of the process flow 500 may support a UE 115-d initiating parallel random access procedures with multiple TRPs 210 (e.g., TRPs 210-d, 210-d) of a network 505 (e.g., an example of a network 205) during a four-step random access procedure to determine TAs to support multi-TRP communication.

The UE 115-d and the network 505 may communicate to enable multi-TRP communication during an initial access procedure. Process flow 500 may be an example of such a process. At least some of the techniques described with reference to process flow 500 may also apply to process flows 300 and 400. For example, at 510, the network 505 may transmit multiple SSBs, each corresponding to a respective TRP of multiple TRPs of the network 505, which may be received by the UE 115-d. In some cases, at 515, the UE 115-d may receive assistance information (e.g., via a SIB) corresponding to the multiple TRPs 210, and transmission of random access messages (e.g., one or more signals) may be based on the assistance information.

In some implementations, the UE 115-d may measure the received SSBs (e.g., signal strength, timing). In some cases, the UE 115-d may report information about the measurements of the SSBs, corresponding to the TRPs 210 of the network 505, to the network 505 during the initial access procedure. For example, the UE 115-d may report signal strength for each SSB in one or more third random access messages (e.g., at 540, 545). The network 505 may use the information reported by the UE 115-d for enabling a multi-TRP communication scheme during the initial access procedure, such as via a fourth random access message at 550.

For the four-step random access procedure, the UE 115-d may transmit a first random access message (e.g., a Msg1), which may include preamble information. The UE 115-d may receive a second random access message (e.g., a random access response, a Msg2) in response to the first random access message. In some examples, the second random access message may include assistance information or additional assistance information, similar to the SIB at 515. In some examples, the assistance information may be related to one or more additional SSBs. The UE 115-d may respond to the second random access message with a third random access message (e.g., a Msg3) that may include shared data (e.g., via a PUSCH). The third random access message may be used to report information on the TRPs 210 based on the SSBs at 510. The network 505 may transmit a fourth random access message (e.g., a Msg4) in response to the third random access message.

In some implementations, during an initial access procedure, signaling sent from the UE 115-d to the network 505 (e.g., random access messages) may be used to determine TA information for a primary TRP 210 (e.g., TRP 210-d). For example, random access messages, prior to multi-TRP communication being enabled, may be communicated with the primary TRP 210 of a network 205. To determine TA information for other (e.g., all) TRPs 210, a UE 115-d may perform parallel initial access procedures for multiple TRPs 210 of the network 505. For example, a TRP 210-d may be a primary TRP 210 for the network 505 and the TRP 210-f may be a secondary TRP 210. The UE 115-d may transmit and receive random access messages corresponding to the initial access procedure with both the TRP 210-d and the TRP 210-f.

For example, at 540 and 545, the UE 115-d may transmit, in an initial access procedure in accordance with receiving the multiple SSBs at 510, one or more signals indicative of one or more TAs, each of the one or more TAs corresponding to a TRP 210 of at least a subset of the multiple TRPs 210. In some cases, the one or more signals may include transmitting a random access message of a first random access procedure corresponding to a first TRP 210 (e.g., primary TRP, TRP 210-d) and a random access message of a second random access procedure corresponding to a second TRP 210 of the multiple TRPs 210 (e.g., secondary TRP 210, TRP 210-f). For a four-step random access procedure, the random access messages may be the first random access messages (e.g., at 520 and 525), the third random access messages (e.g., at 540 and 545), or a combination thereof. At 550, the UE 115-d may receive a random access response (e.g., a fourth random access message) that may indicate of the UE 115-d to communicate with the network 505 via a subset of the multiple TRPs 210 in accordance with the one or more TAs based on transmitting the random access messages at 520, 525, 540, 545, or a combination thereof. The random access response may be a fourth random access message of the first random access procedure, the second random access procedure, or a combination thereof.

In some cases, the UE 115-d may autonomously determine to perform a parallel random access procedure with the secondary TRP 210 (e.g., TRP 210-f), as well as the primary TRP 210 (e.g., TRP 210-d). For example, at 520, the UE 115-d may send a first random access message of a first four-step random access procedure to the TRP 210-d. At 525, the UE 115-d may send a first random access message of a second four-step random access procedure to the TRP 210-f. In some cases, the UE 115-d may start the parallel random access procedures based on measurements, such as of the SSBs at 510. In response to the first random access messages, at 530 and 535 the UE 115-d may receive responses (e.g., second random access messages) from the TRP 210-d and the TRP 210-f.

At 540 and 545, the UE 115-d may transmit third random access messages of the first four-step random access procedure and the second four-step random access procedure to the respective TRPs 210 (e.g., TRP 210-d, TRP 210-f). Based on receiving the third random access messages at 540 and 545, the different TRPs 210 may obtain parallel random access channels (RACHs) from the same UE 115-d and the network 505 may determine (e.g., establish, acquire, derive, calculate) TAs for the multiple TRPs 210. Accordingly, the network 505 may enable multi-TRP communication (e.g., via the fourth random access message at 550). The random access procedures, although performed in parallel, may otherwise be the same or similar to standalone random access procedures with a single TRP 210, but may enable multi-TRP communication and may establish TAs for uplink multi-TRP communication.

At 550, the UE 115-d may receive one or more of a fourth random access message from the TRP 210-d, the TRP 210-f, or a combination thereof. For example, a network 505 may determine to enable multi-TRP communication, and may send an enablement indication in the fourth random access message at 550. In some examples, the network 505 may implement multi-TRP communication scheme for the fourth random access message at 550. In some cases, to reduce overhead for the network 505 and the UE 115-d, the network 505 may transmit the fourth random access message at 550 according to the multi-TRP communication scheme, which may indicate for the UE 115-d to stop monitoring for a fourth random access message for the second random access procedure, or to stop monitoring for the fourth random access message of the parallel random access procedure from other TRPs 210.

At 555, the UE 115-d may communicate with the network 505 via the subset of the multiple TRPs 210 in accordance with the TAs corresponding to the subset of the multiple TRPs 210. For example, the UE 115-d may transmit a feedback message that may indicate that the initial access procedure was successful. The UE 115-d may transmit the feedback message to one or more TRPs 210 of the network 505 in accordance with the one or more TAs established during the initial access procedure (e.g., via the parallel random access procedures). In some examples, by triggering transmission of the secondary TRP signals (e.g., PRACH signals, reference signals, such as SRSs) during an initial access procedure while enabling multi-TRP communication, the described techniques can be used to efficiently determine TAs based on reference signals with minimal or reduced extra signaling. In some examples, implementing parallel random access procedures with multiple TRPs 210 may be used to determine TAs during an initial access procedure, leveraging existing types of signaling and procedures for determining TAs for primary TRPs 210, to improve communication reliability and enable multi-TRP communication. In some examples, parallel random access procedures initiated by a UE 115 may reduce overhead (e.g., no trigger signaling) and reduce latency by performing the parallel random access procedures at a same time.

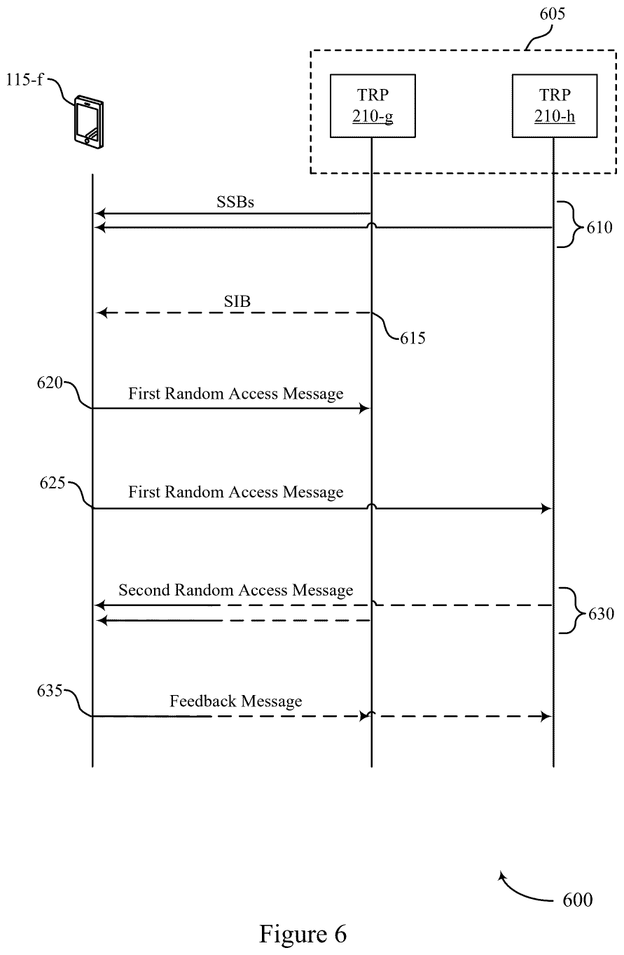

FIG. 6 shows an example of a process flow 600 that supports TA establishment during initial access for multi-TRP systems. The process flow 600 may implement, or be implemented by, aspects of the wireless communication system 100, the signaling configuration 200, and the process flows 300, 400, and 500. For example, the process flow 600 may include one or more UEs 115, including at least the UE 115-f. The techniques described in the context of the process flow 600 may support a UE 115-f initiating parallel random access procedures with multiple TRPs (e.g., TRPs 210-g, 210-h) of a network 605 (e.g., an example of a network 205) during a two-step random access procedure to determine TAs to support multi-TRP communication.

Process flow 500 may illustrate UE-initiated parallel random access procedures for a four-step random access procedure. In some cases, the initial access procedure may be a two-step random access procedure. Process flow 600 may illustrate a UE-initiated parallel random access procedure for a two-step random access procedure. At least some of the techniques discussed with reference to process flow 500 may apply to process flow 600. For example, at 610, the network 605 may transmit multiple SSBs, each corresponding to a respective TRP 210 of multiple TRPs 210 of the network 605, which may be received by the UE 115-f. In some cases, at 615, the UE 115-f may receive assistance information (e.g., via a SIB) corresponding to the multiple TRPs, and transmission of random access messages (e.g., one or more signals) may be based on the assistance information.

For the two-step random access procedure, the UE 115-f may transmit a first random access message (e.g., a MsgA), which may include preamble information and shared data. The second random access message may be used to report information on the TRPs based on the SSBs at 610. The UE 115-f may receive a second random access message (e.g., random access response) in response to the first random access message (e.g., a MsgB).

Similar to aspects of the process flow 500, a UE 115-f may perform parallel random access procedures with TRPs 210 of the network 605 to determine TAs for the TRPs 210 and enable uplink multi-TRP communication. For example, a TRP 210-g may be a primary TRP 210 for the network 605 and the TRP 210-h may be a secondary TRP 210. The UE 115-f may transmit and receive random access messages corresponding to the initial access procedure with both the TRP 210-g and the TRP 210-h.

For example, at 620 and 625, the UE 115-f may transmit, in an initial access procedure in accordance with receiving the multiple SSBs at 610, one or more signals indicative of one or more TAs, each of the one or more TAs corresponding to a TRP 210 of at least a subset of the multiple TRPs 210. In some cases, as in process flow 500, the one or more signals may include transmitting a random access message of a first random access procedure corresponding to a first TRP 210 (e.g., primary TRP 210, TRP 210-g) and a random access message of a second random access procedure corresponding to a second TRP 210 of the multiple TRPs 210 (e.g., secondary TRP 210, TRP 210-h). For the two-step random access procedure, the random access messages may be first random access messages of the respective random access procedures. For example, at 620, the UE 115-f may transmit a first random access message of a first two-step random access procedure to a first TRP 210 (e.g., TRP 210-g). At 625, the UE 115-f may transmit a first random access message of a second two-step random access procedure to a second TRP 210 (e.g., TRP 210-h). The network 605 may use the received first random access messages as reference signals for determining TAs for the respective TRPs 210.

At 630, the UE 115-f may receive a random access response (e.g., second random access message) that may indicate for the UE 115-f to communicate with the network 605 via a subset of the multiple TRPs 210 in accordance with the one or more TAs based on transmitting the random access messages at 620 and 625. The random access response may be a second random access message of the first random access procedure, the second random access procedure, or a combination thereof. For example, the second random access message may be transmitted from the TRP 210-g, the TRP 210-h, or a combination thereof. The second random access message may indicate the TAs and may enable or indicate to enable one or more multi-TRP communication schemes.

At 635, the UE 115-f may communicate with the network 605 via the subset of the multiple TRPs 210 in accordance with the TAs corresponding to the subset of the multiple TRPs 210. For example, the UE 115-f may transmit a feedback message that may indicate that the initial access procedure was successful. The UE 115-f may transmit the feedback message to one or more TRPs 210 of the network 605 in accordance with the one or more TAs established during the initial access procedure (e.g., via the parallel random access procedures). In some examples, implementing parallel random access procedures with multiple TRPs 210 may be used to determine TAs in an initial access procedure, leveraging existing types of signaling and procedures for determining TAs for primary TRPs 210, to improve communication reliability and enable multi-TRP communication. In some examples, parallel random access procedures initiated by a UE 115 may reduce overhead (e.g., no trigger signaling) and reduce latency by performing the parallel random access procedures at a same time. In some examples, a two-step random access procedure may be more time-efficient, reducing latency and overhead, than a four-step random access procedure.

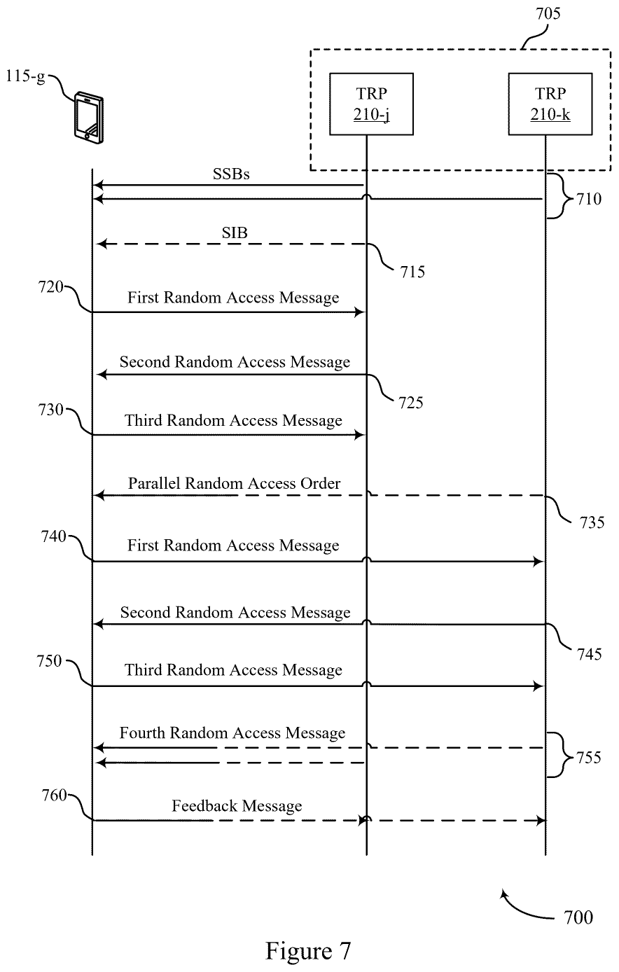

FIG. 7 shows an example of a process flow 700 that supports TA establishment during initial access for multi-TRP systems. The process flow 700 may implement, or be implemented by, aspects of the wireless communication system 100, the signaling configuration 200, and the process flows 300, 400, 500, and 600. For example, the process flow 700 may include one or more UEs 115, including at least the UE 115-g. The techniques described in the context of the process flow 700 may support a network 705 (e.g., an example of a network 205) triggering a UE 115-g to perform parallel random access procedures with multiple TRPs 210 (e.g., TRPs 210-j, 210-k) of the network 705 during a four-step random access procedure to determine TAs to support multi-TRP communication.

Process flows 500 and 600 illustrate UE-initiated parallel random access procedures. In some cases, the network 705 may trigger the parallel random access procedure. Process flow 700 may illustrate a network-triggered parallel random access procedure for a four-step random access procedure. At least some of the techniques discussed with reference to process flows 500 and 600 may apply to process flow 700. For example, at 710, the network 705 may transmit (e.g., using multiple TRPs 210) multiple SSBs, each corresponding to a respective TRP 210 of multiple TRPs 210 of the network 705, which may be received by the UE 115-g. In some cases, at 715, the UE 115-g may receive assistance information (e.g., via a SIB) corresponding to the multiple TRPs, and transmission of random access messages (e.g., one or more signals) may be based on the assistance information.

In some implementations, the network 705 may indicate to the UE 115-g to perform a parallel random access procedure. For example, at 720, the UE 115-g may transmit a first random access message of a first four-step random access procedure to a primary TRP 210 of the network 705 (e.g., TRP 210-j). At 725, the TRP 210-j may respond with a second random access message of the first four-step random access procedure (e.g., a random access response) responsive to the first random access at 720. At 730, the UE 115-g may transmit a third random access message of the four-step random access procedure to the TRP 210-j. Rather than sending a fourth and final random access message of the first four-step random access procedure, the network 705 (e.g., using TRP 210-j, TRP 210-k, or a combination thereof) may send a parallel random access order (e.g., parallel RACH order), triggering the UE 115-g to perform a random access procedure with a secondary TRP 210. For example, the UE 115-g may be indicated or triggered to begin a second random access procedure with secondary TRPs 210, in addition to the primary TRP 210. In some cases, the secondary TRPs 210 may be based on a multi-TRP report transmitted in the third random access message at 730. For example, after receiving the multi-TRP report (e.g., measurement report) in the third random access message at 730, the network 705 may determine additional TRPs 210 to use for multi-TRP communication with the UE 115-g. The network 705 may then trigger the UE 115-g to begin parallel random access procedures for those TRPs 210 via the parallel random access order at 735.

In accordance with the parallel random access order, at 740, the UE 115-g may transmit a first random access message of a second four-step RACH procedure to a secondary TRP 210, such as the TRP 210-k. At 745, the TRP 210-k may transmit a second random access message of the second four-step random access procedure in response. At 750, the UE 115-g may transmit a third random access message of the second four-step random access procedure to the TRP 210-k. In some cases, the third random access message at 750 may not include a measurement report or a multi-TRP report (e.g., may contain existing contents). After receiving a third random access message of a respective random access procedure on all relevant TRPs 210, at 755 the network 705 may transmit a fourth random access message indicating or enabling multi-TRP communication. For example, the fourth random access message at 755 may be transmitted by the TRP 210-j, the TRP 210-k, or a combination thereof. After receiving the fourth random access message at 755, the UE 115-g may refrain from monitoring for separate fourth random access messages from each TRP corresponding to the parallel random access procedures.

For example, at 730 and 750, the UE 115-g may transmit, in an initial access procedure in accordance with receiving the multiple SSBs at 710, one or more signals indicative of one or more TAs, each of the one or more TAs corresponding to a TRP 210 of at least a subset of the multiple TRPs 210. In some cases, the one or more signals may include transmitting a random access message of a first random access procedure corresponding to a first TRP 210 (e.g., primary TRP 210, TRP 210-j) and a random access message of a second random access procedure corresponding to a second TRP 210 of the multiple TRPs 210 (e.g., secondary TRP 210, TRP 210-k). For a four-step random access procedure, the random access messages may be the third random access messages (e.g., at 730 and 750). In some cases, at 735, the UE 115-g may receive an indication (e.g., parallel random access order) of at least the second TRP 210 (e.g., TRP 210-k), and transmitting the random access message of the second random access procedure may be in response to receiving the indication. For example, the network 705 may trigger the second random access procedure, and may indicate a relevant TRP 210. At 755, the UE 115-g may receive a random access response (e.g., fourth random access message) that may indicate of the UE 115-g to communicate with the network 705 via a subset of the multiple TRPs 210 in accordance with the one or more TAs based on transmitting the random access messages at 730 and 750. The random access response may be a fourth random access message of the first random access procedure, the second random access procedure, or a combination thereof.

At 760, the UE 115-g may communicate with the network 705 via the subset of the multiple TRPs 210 in accordance with the TAs corresponding to the subset of the multiple TRPs 210. For example, the UE 115-g may transmit a feedback message that may indicate that the initial access procedure was successful. The UE 115-g may transmit the feedback message to one or more TRPs 210 of the network 705 in accordance with the one or more TAs established during the initial access procedure (e.g., via the parallel random access procedures). In some examples, implementing parallel random access procedures with multiple TRPs 210 may be used to determine TAs in an initial access procedure, leveraging existing types of signaling and procedures for determining TAs for primary TRPs 210, to improve communication reliability and enable multi-TRP communication. In some examples, parallel random access procedures triggered by the network may reduce energy usage and processing at the UE 115-g, as well as use information in a multi-TRP report at 730 to inform the UE 115-g of secondary TRPs 210 at 735.

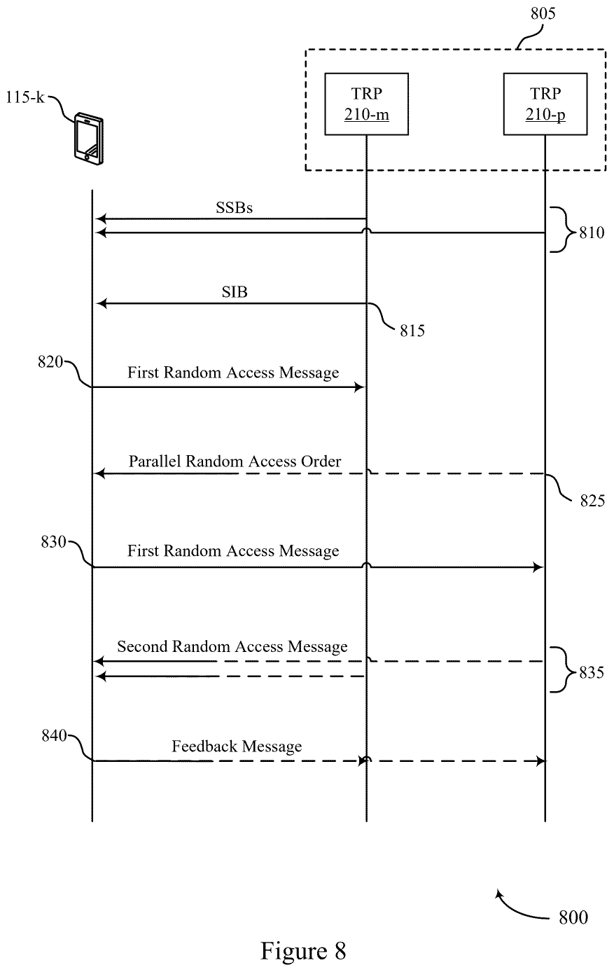

FIG. 8 shows an example of a process flow 800 that supports TA establishment during initial access for multi-TRP systems. The process flow 700 may implement, or be implemented by, aspects of the wireless communication system 100, the signaling configuration 200, and the process flows 300, 400, 500, 600, and 700. For example, the process flow 700 may include one or more UEs 115, including at least the UE 115-g. The techniques described in the context of the process flow 800 may support a network 805 (e.g., an example of a network 205) triggering a UE 115-k to perform parallel random access procedures with multiple TRPs 210 (e.g., TRPs 210-m, 210-p) of the network 805 during a two-step random access procedure to determine TAs to support multi-TRP communication.

Process flow 700 illustrates network-triggered parallel random access procedures for a four-step random access procedure. In some cases, the initial access procedure may be a two-step random access procedure instead. Process flow 800 may illustrate a network-triggered parallel random access procedure for a two-step random access procedure. One or more of the techniques discussed with reference to process flow 700 may apply to process flow 800. For example, at 810, the network 805 may transmit multiple SSBs, each corresponding to a respective TRP 210 of multiple TRPs 210 of the network 805, which may be received by the UE 115-k. In some cases, at 815, the UE 115-k may receive assistance information (e.g., via a SIB) corresponding to the multiple TRPs, and transmission of random access messages (e.g., one or more signals) may be based on the assistance information.

At 820, the UE 115-k may transmit a first random access message of a first two-step random access procedure to a first TRP 210, such as the TRP 210-m. At 825, the UE 115-f may receive a parallel random access order from the network 805 (e.g., TRP 210-m, TRP 210-p). The parallel random access order may indicate to the UE 115-k to perform a parallel random access procedure for one or more secondary TRPs 210, such as the TRP 210-p. At 830, in response to receiving the parallel random access order at 825, the UE 115-k may transmit a first random access message of a second two-step random access procedure to a second TRP 210 (e.g., TRP 210-p). The network 805 may use the received first random access messages as reference signals for determining TAs for the respective TRPs 210. The network 805 may transmit a second random access message at 835. The second random access message may be transmitted from the TRP 210-m, the TRP 210-p, or a combination thereof. The second random access message may indicate the TAs and may enable or indicate to enable one or more multi-TRP communication schemes.

For example, at 820 and 830, the UE 115-k may transmit, in an initial access procedure in accordance with receiving the multiple SSBs at 810, one or more signals indicative of one or more TAs, each of the one or more TAs corresponding to a TRP 210 of at least a subset of the multiple TRPs 210. In some cases, the one or more signals may include transmitting a random access message of a first random access procedure corresponding to a first TRP 210 (e.g., primary TRP 210, TRP 210-m) and a random access message of a second random access message procedure corresponding to a second TRP 210 of the multiple TRPs 210 (e.g., secondary TRP 210, TRP 210-p). For a two-step random access procedure, the random access messages may be the first random access messages (e.g., at 820 and 830). In some cases, at 825, the UE 115-k may receive an indication of at least the second TRP 210 (e.g., TRP 210-p), and transmission of the random access message of the second random access procedure may be in response to receiving the indication (e.g., parallel random access order). For example, the network 805 may trigger the second random access procedure, and may indicate a relevant TRP 210 at 825. At 835, the UE 115-d may receive a random access response (e.g., second random access message) that may indicate for the UE 115-k to communicate with the network 805 via a subset of the multiple TRPs 210 in accordance with the one or more TAs based on transmitting the random access messages at 820 and 830. The random access response may be a second random access message of the first random access procedure, the second random access procedure, or a combination thereof.

At 840, the UE 115-k may communicate with the network 705 via the subset of the multiple TRPs 210 in accordance with the TAs corresponding to the subset of the multiple TRPs 210. For example, the UE 115-k may transmit a feedback message that may indicate that the initial access procedure was successful. The UE 115-k may transmit the feedback message to one or more TRPs 210 of the network 805 in accordance with the one or more TAs established during the initial access procedure (e.g., via the parallel random access procedures). In some examples, implementing parallel random access procedures with multiple TRPs 210 may be used to determine TAs in an initial access procedure, leveraging existing types of signaling and procedures for determining TAs for primary TRPs 210, to improve communication reliability and enable multi-TRP communication. In some examples, parallel random access procedures triggered by the network may reduce energy usage and processing at the UE 115-k, as well as use information in a multi-TRP report at 235 to inform the UE 115-k of secondary TRPs 210 at 825.

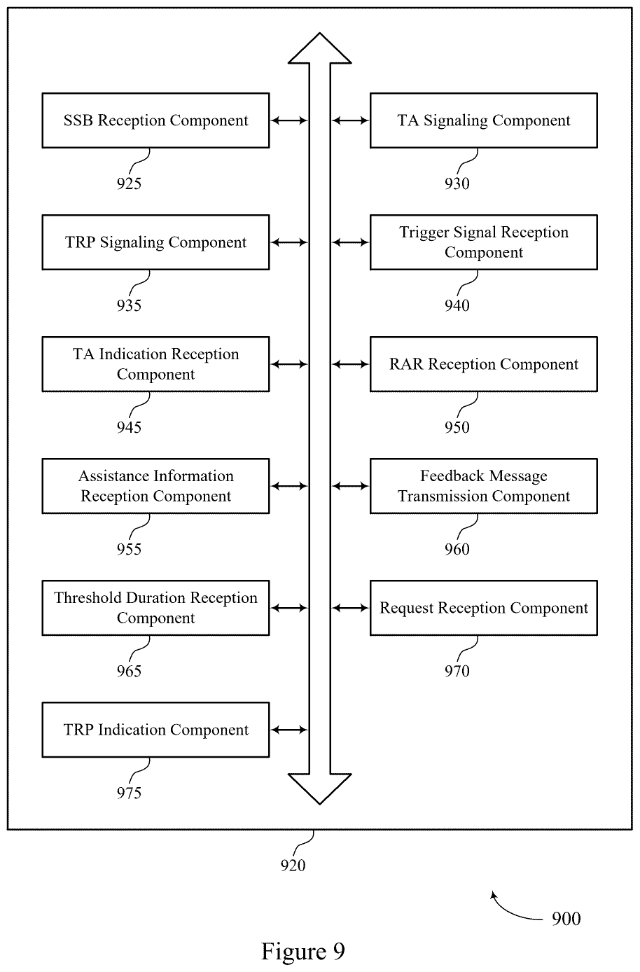

FIG. 9 shows an example 900 of a processing system 920 that supports TA establishment during initial access for multi-TRP systems. A processing system 920 may be an example of a processing system 140 (such as of a UE 115) and may include an SSB reception component 925, a TA signaling component 930, an TRP signaling component 935, a trigger signal reception component 940, a TA indication reception component 945, a RAR reception component 950, an assistance information reception component 955, a feedback message transmission component 960, a threshold duration reception component 965, a request reception component 970, an TRP indication component 975, or any combination thereof. A processing system 920, or various component thereof, may be an example of means for performing (such as a means for causing a UE 115 to perform) various techniques described herein.

The SSB reception component 925 may be configured to cause the UE 115 to receive a set of multiple SSBs each corresponding to a respective TRP of a set of multiple TRPs of a network. The TA signaling component 930 may be configured to cause the UE 115 to transmit, in an initial access procedure in accordance with receiving the set of multiple SSBs, one or more signals indicative of one or more TAs, each of the one or more TAs corresponding to a TRP of at least a subset of the set of multiple TRPs. The TRP signaling component 935 may be configured to cause the UE 115 to communicate with the network via the subset of the set of multiple TRPs in accordance with the TAs corresponding to the subset of the set of multiple TRPs.

In some examples, to support transmitting the one or more signals, the TA signaling component 930 may be configured to cause the UE 115 to transmit, transmit, based on a duration of receiving at least a subset of SSBs of the set of multiple SSBs satisfying a threshold duration, a random access message that indicates the at least the subset of the set of multiple TRPs, the at least the subset of SSBs corresponding to the at least the subset of the set of multiple TRPs.

In some examples, the threshold duration reception component 965 may be configured to cause the UE 115 to receive an indication of the threshold duration.

In some examples, the trigger signal reception component 940 may be configured to cause the UE 115 to receive one or more second signals, different than the set of multiple SSBs, that trigger transmission of the one or more signals, the one or more signals including one or more PRACH signals, one or more SRSs, or a combination thereof. In some examples, the TA indication reception component 945 may be configured to cause the UE 115 to receive, in response to transmitting the one or more signals, an indication of the one or more TAs.

In some examples, the initial access procedure corresponds to a two-step random access procedure, and a second message of the two-step random access procedure may include the one or more second signals or the indication of the one or more TAs.

In some examples, the initial access procedure corresponds to a four-step random access procedure, and a fourth message of the four-step random access procedure may include the one or more second signals or the indication of the one or more TAs.

In some examples, the one or more signals include a random access message of the initial access procedure that indicates the at least the subset of the set of multiple TRPs in response to receiving the set of multiple SSBs, and the RAR reception component 950 may be configured to cause the UE 115 to receive, in response to transmitting the one or more signals, a random access response of the initial access procedure that indicates the one or more TAs.

In some examples, the request reception component 970 may be configured to cause the UE 115 to receive a request to transmit, using the random access message, timing information based on the set of multiple SSBs, and the one or more TAs may be based on transmitting the timing information.

In some examples, the one or more signals includes a first random access message of a first random access procedure corresponding to a first TRP and a second random access message of a second random access procedure corresponding to a second TRP of the set of multiple TRPs, and the RAR reception component 950 may be configured to cause the UE 115 to receive a random access response that indicates to communicate with the network via the subset of the set of multiple TRPs in accordance with the one or more TAs, the one or more TAs based on transmitting the first random access message and the second random access message of the second random access procedure.

In some examples, the TRP indication component 975 may be configured to cause the UE 115 to receive an indication of at least the second TRP, and transmitting the second random access message of the second random access procedure may be in response to receiving the indication.

In some examples, the first random access procedure and the second random access procedure correspond to a four-step random access procedure, and the random access response may be a fourth message, of the four-step random access procedure, of the first random access procedure, the second random access procedure, or both.

In some examples, the first random access procedure and the second random access procedure correspond to a two-step random access procedure, and the random access response may be a second message, of the two-step random access procedure, of the first random access procedure, the second random access procedure, or both.

In some examples, the assistance information reception component 955 may be configured to cause the UE 115 to receive assistance information corresponding to the set of multiple TRPs, and transmitting the one or more signals may be based on the assistance information.

In some examples, to support communicating with the network, the feedback message transmission component 960 may be configured to cause the UE 115 to transmit a feedback message that indicates that the initial access procedure was successful.

A processing system 920 may include or be a component of one or more chips, systems-on-chips (SoCs), chipsets, packages, components, or devices that individually or collectively constitute or include a processing system. A processing system 920 may interface with other components of a processing system 920. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a processing system 920).

By including or configuring a processing system 920 for operation in a processing system 920 as described herein, the processing system 920 may support techniques for improved communication reliability, reduced latency, more efficient utilization of communication resources, improved coordination between devices, and improved utilization of processing capability.

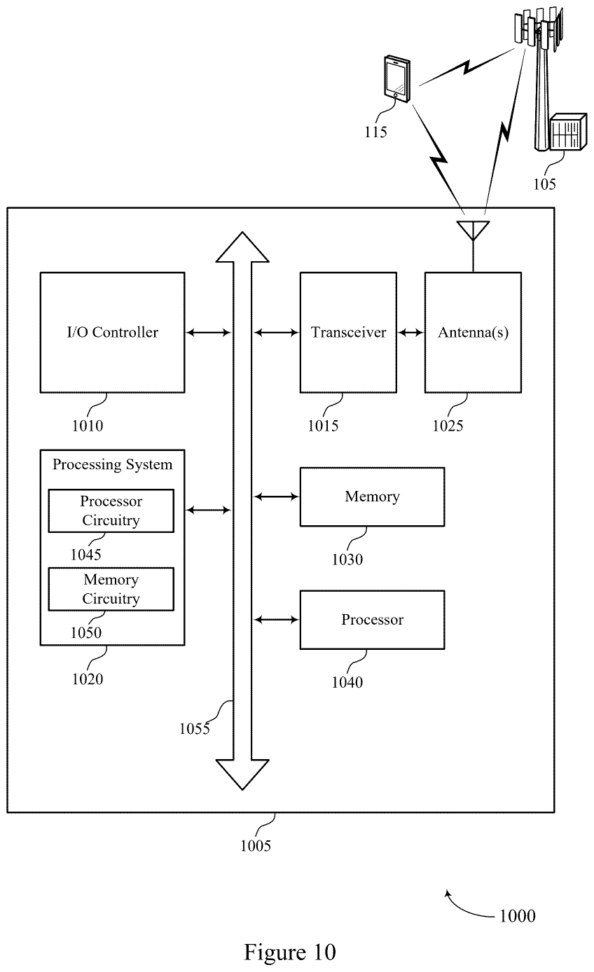

FIG. 10 shows an example of a system 1000 including a device 1005 that supports TA establishment during initial access for multi-TRP systems. The device 1005 may be an example of or include components of UE 115. The device 1005 may communicate (such as wirelessly) with one or more other devices (such as network entities 105, UEs 115). The device 1005 may include components for transmitting and receiving communication, which may include a processing system 1020, an input/output (I/O) controller, such as an I/O controller 1010, a transceiver 1015, antenna(s) 1025, a memory 1030, and a processor 1040. Components of the device 1005 may be coupled (such as operatively, communicatively, functionally, electronically, electrically, in electronic communication) a bus 1055.

The transceiver 1015 may support bi-directional communication via antenna(s) 1025, and may support transmission operations, reception operations, or both, as described herein. The transceiver 1015 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1005). The transceiver 1015 may modulate symbols and provide the modulated symbols to antenna(s) 1025 for transmission, and demodulate symbols from signals received using antenna(s) 1025.

The processor 1040 may be a general-purpose processing component that supports various operations (such as applications) of the device 1005. The memory 1030 may be a general-purpose storage component that stores code executable by the processor 1040. Such code may include instructions that, when executed by the processor 1040 (e.g., directly, indirectly, without pre-processing, after pre-processing), cause the device 1005 to perform various functions (such as to support an application of the device 1005). The I/O controller 1010 may manage inputs and outputs for the device 1005, may manage peripherals not integrated into the device 1005, or may represent a physical connection (such as port) to an external peripheral. The processor 1040 may interact with a modem, a keyboard, a mouse, a touchscreen, or other device (such as via I/O controller 1010). In some implementations, a user may interact with the device 1005 via the I/O controller 1010 or via hardware components controlled by the I/O controller 1010.

The processing system 1020 may be an example of a processing system 140 or a processing system 920. For example, the processing system 1020 may include processor circuitry 1045 and memory circuitry 1050 that stores code, and may be configured to cause the device 1005 to perform operations that support TA establishment during initial access for multi-TRP systems. Although the processing system 1020 is illustrated as a separate component, which may involve a separate chip, chipset, or other module, in some implementations, one or more functions described with reference to the processing system 1020 may be supported by or performed by a transceiver 1015, antenna(s) 1025, a processor 1040, memory 1030, or any combination thereof, such that a processing system 1020 may include one or more of a transceiver 1015, antenna(s) 1025, a processor 1040, memory 1030, or any combination thereof.

By including or configuring the processing system 1020 for operation in the device 1005 as described herein, may support techniques for improved communication reliability, reduced latency, more efficient utilization of communication resources, improved coordination between devices, and improved utilization of processing capability.

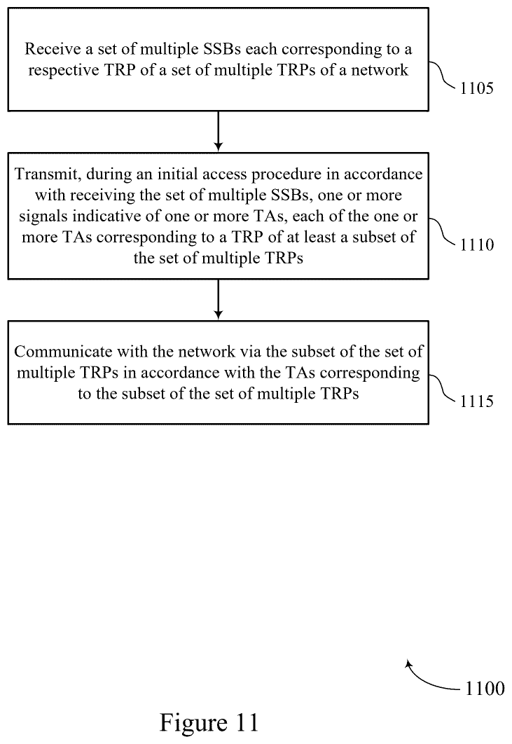

FIG. 11 shows an example of a method 1100 that supports TA establishment during initial access for multi-TRP systems. Operations of the method 1100 may be performed by a UE or its components (such as using a processing system configured to cause the UE 115 to perform one or more of the operations) as described herein.

At 1105, the method may include receiving a set of multiple SSBs each corresponding to a respective TRP of a set of multiple TRPs of a network. In some examples, aspects of the operations of 1105 may be performed by an SSB reception component 925.

At 1110, the method may include transmitting, in an initial access procedure in accordance with receiving the set of multiple SSBs, one or more signals indicative of one or more TAs, each of the one or more TAs corresponding to a TRP of at least a subset of the set of multiple TRPs. In some examples, aspects of the operations of 1110 may be performed by a TA signaling component 930.

At 1115, the method may include communicating with the network via the subset of the set of multiple TRPs in accordance with the TAs corresponding to the subset of the set of multiple TRPs. In some examples, aspects of the operations of 1115 may be performed by an TRP signaling component 935.

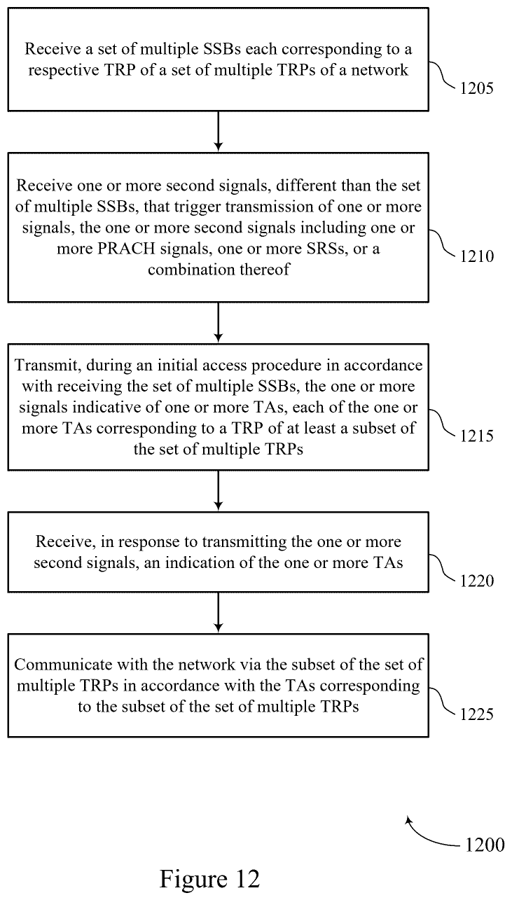

FIG. 12 shows an example of a method 1200 that supports TA establishment during initial access for multi-TRP systems. Operations of the method 1200 may be performed by a UE or its components (such as using a processing system configured to cause the UE 115 to perform one or more of the operations) as described herein.

At 1205, the method may include receiving a set of multiple SSBs each corresponding to a respective TRP of a set of multiple TRPs of a network. In some examples, aspects of the operations of 1205 may be performed by an SSB reception component 925.

At 1210, the method may include receiving one or more second signals, different than the set of multiple SSBs, that trigger transmission of one or more signals, the one or more signals including one or more PRACH signals, one or more SRSs, or a combination thereof. In some examples, aspects of the operations of 1210 may be performed by a trigger signal reception component 940.

At 1215, the method may include transmitting, in an initial access procedure in accordance with receiving the set of multiple SSBs, the one or more signals indicative of one or more TAs, each of the one or more TAs corresponding to a TRP of at least a subset of the set of multiple TRPs. In some examples, aspects of the operations of 1215 may be performed by a TA signaling component 930.

At 1220, the method may include receiving, in response to transmitting the one or more signals, an indication of the one or more TAs. In some examples, aspects of the operations of 1220 may be performed by a TA indication reception component 945.

At 1225, the method may include communicating with the network via the subset of the set of multiple TRPs in accordance with the TAs corresponding to the subset of the set of multiple TRPs. In some examples, aspects of the operations of 1225 may be performed by an TRP signaling component 935.

Implementation examples are described in the following numbered clauses:
Aspect 1: A method for wireless communications at a UE, comprising: receiving a plurality of SSBs each corresponding to a respective TRP of a plurality of TRPs of a network; transmitting, in an initial access procedure in accordance with receiving the plurality of SSBs, one or more signals indicative of one or more TAs, each of the one or more TAs corresponding to a TRP of at least a subset of the plurality of TRPs; and communicating with the network via the subset of the plurality of TRPs in accordance with the TAs corresponding to the subset of the plurality of TRPs.

Aspect 2: The method of aspect 1, wherein transmitting the one or more signals comprises: transmitting, based at least in part on a duration of receiving at least a subset of SSBs of the plurality of SSBs satisfying a threshold duration, a random access message that indicates the at least the subset of the plurality of TRPs, the at least the subset of SSBs corresponding to the at least the subset of the plurality of TRPs.

Aspect 3: The method of aspect 2, further comprising: receiving an indication of the threshold duration.

Aspect 4: The method of any of aspects 1 through 3, further comprising: receiving one or more second signals, different than the plurality of SSBs, that trigger transmission of the one or more signals, the one or more signals comprising one or more PRACH signals, one or more SRSs, or a combination thereof; and receiving, in response to transmitting the one or more signals, an indication of the one or more TAs.

Aspect 5: The method of aspect 4, wherein the initial access procedure corresponds to a two-step random access procedure, and a second message of the two-step random access procedure comprises the one or more second signals or the indication of the one or more TAs.

Aspect 6: The method of aspect 4, wherein the initial access procedure corresponds to a four-step random access procedure, and a fourth message of the four-step random access procedure includes the one or more second signals or the indication of the one or more TAs.

Aspect 7: The method of any of aspects 1 through 6, wherein the one or more signals comprise a random access message of the initial access procedure that indicates the at least the subset of the plurality of TRPs in response to receiving the plurality of SSBs, the method further comprising: receiving, in response to transmitting the one or more signals, a random access response of the initial access procedure that indicates the one or more TAs.

Aspect 8: The method of aspect 7, further comprising: receiving a request to transmit, using the random access message, timing information based at least in part on the plurality of SSBs, wherein the one or more TAs are based at least in part on transmitting the timing information.

Aspect 9: The method of any of aspects 1 through 8, wherein the one or more signals comprises a first random access message of a first random access procedure corresponding to a first TRP and a second random access message of a second random access procedure corresponding to a second TRP of the plurality of TRPs, the method further comprising: receiving a random access response that indicates to communicate with the network via the subset of the plurality of TRPs in accordance with the one or more TAs, the one or more TAs based at least in part on transmitting the first random access message and the second random access message of the second random access procedure.

Aspect 10: The method of aspect 9, further comprising: receiving an indication of at least the second TRP, wherein transmitting the second random access message of the second random access procedure is in response to receiving the indication.

Aspect 11: The method of any of aspects 9 through 10, wherein the first random access procedure and the second random access procedure correspond to a four-step random access procedure, and the random access response is a fourth message, of the four-step random access procedure, of the first random access procedure, the second random access procedure, or both.

Aspect 12: The method of any of aspects 9 through 10, wherein the first random access procedure and the second random access procedure correspond to a two-step random access procedure, and the random access response is a second message, of the two-step random access procedure, of the first random access procedure, the second random access procedure, or both.

Aspect 13: The method of any of aspects 1 through 12, further comprising: receiving assistance information corresponding to the plurality of TRPs, wherein transmitting the one or more signals is based at least in part on the assistance information.

Aspect 14: The method of any of aspects 1 through 13, wherein communicating with the network comprises: transmitting a feedback message that indicates that the initial access procedure was successful.

Aspect 15: A UE for wireless communications, comprising a processing system that includes processor circuitry and memory circuitry that stores code, the processing system configured to cause the UE to perform a method of any of aspects 1through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a plurality of synchronization signal blocks (SSBs) each corresponding to a respective transmission and reception point (TRP) of a plurality of TRPs of a network;
transmit, in an initial access procedure in accordance with receiving the plurality of SSBs, one or more signals indicative of one or more timing advances, each of the one or more timing advances corresponding to a TRP of at least a subset of the plurality of TRPs; and
communicate with the network via the subset of the plurality of TRPs in accordance with the timing advances corresponding to the subset of the plurality of TRPs.

2. The UE of claim 1, wherein, to transmit the one or more signals, the processing system is configured to cause the UE to:
transmit, based at least in part on a duration of receiving at least a subset of SSBs of the plurality of SSBs satisfying a threshold duration, a random access message that indicates the at least the subset of the plurality of TRPs, the at least the subset of SSBs corresponding to the at least the subset of the plurality of TRPs.

3. The UE of claim 2, wherein the processing system is further configured to cause the UE to:
receive an indication of the threshold duration.

4. The UE of claim 1, wherein the processing system is further configured to cause the UE to:
receive one or more second signals, different than the plurality of SSBs, that trigger transmission of the one or more signals, the one or more signals comprising one or more physical random access channel signals, one or more sounding reference signals, or a combination thereof; and
receive, in response to transmitting the one or more signals, an indication of the one or more timing advances.

5. The UE of claim 4, wherein the initial access procedure corresponds to a two-step random access procedure, and a second message of the two-step random access procedure comprises the one or more second signals or the indication of the one or more timing advances.

6. The UE of claim 4, wherein the initial access procedure corresponds to a four-step random access procedure, and a fourth message of the four-step random access procedure includes the one or more second signals or the indication of the one or more timing advances.

7. The UE of claim 1, wherein the one or more signals comprise a random access message of the initial access procedure that indicates the at least the subset of the plurality of TRPs in response to receiving the plurality of SSBs, and the processing system is further configured to cause the UE to:
receive, in response to transmitting the one or more signals, a random access response of the initial access procedure that indicates the one or more timing advances.

8. The UE of claim 7, wherein the processing system is further configured to cause the UE to:
receive a request to transmit, using the random access message, timing information based at least in part on the plurality of SSBs, wherein the one or more timing advances are based at least in part on transmitting the timing information.

9. The UE of claim 1, wherein the one or more signals comprises a first random access message of a first random access procedure corresponding to a first TRP and a second random access message of a second random access procedure corresponding to a second TRP of the plurality of TRPs, and the processing system is further configured to cause the UE to:
receive a random access response that indicates to communicate with the network via the subset of the plurality of TRPs in accordance with the one or more timing advances, the one or more timing advances based at least in part on transmitting the first random access message and the second random access message of the second random access procedure.

10. The UE of claim 9, wherein the processing system is further configured to cause the UE to:
receive an indication of at least the second TRP, wherein transmitting the second random access message of the second random access procedure is in response to receiving the indication.

11. The UE of claim 9, wherein the first random access procedure and the second random access procedure correspond to a four-step random access procedure, and the random access response is a fourth message, of the four-step random access procedure, of the first random access procedure, the second random access procedure, or both.

12. The UE of claim 9, wherein the first random access procedure and the second random access procedure correspond to a two-step random access procedure, and the random access response is a second message, of the two-step random access procedure, of the first random access procedure, the second random access procedure, or both.

13. The UE of claim 1, wherein the processing system is further configured to cause the UE to:
receive assistance information corresponding to the plurality of TRPs, wherein transmitting the one or more signals is based at least in part on the assistance information.

14. The UE of claim 1, wherein, to communicate with the network, the processing system is configured to cause the UE to:
transmit a feedback message that indicates that the initial access procedure was successful.

15. A method for wireless communications at a user equipment (UE), comprising:
receiving a plurality of synchronization signal blocks (SSBs) each corresponding to a respective transmission and reception point (TRP) of a plurality of TRPs of a network;
transmitting, in an initial access procedure in accordance with receiving the plurality of SSBs, one or more signals indicative of one or more timing advances, each of the one or more timing advances corresponding to a TRP of at least a subset of the plurality of TRPs; and
communicating with the network via the subset of the plurality of TRPs in accordance with the timing advances corresponding to the subset of the plurality of TRPs.

16. The method of claim 15, wherein transmitting the one or more signals comprises:
transmitting, based at least in part on a duration of receiving at least a subset of SSBs of the plurality of SSBs satisfying a threshold duration, a random access message that indicates the at least the subset of the plurality of TRPs, the at least the subset of SSBs corresponding to the at least the subset of the plurality of TRPs.

17. The method of claim 15, further comprising:
receiving one or more second signals, different than the plurality of SSBs, that trigger transmission of the one or more signals, the one or more signals comprising one or more physical random access channel signals, one or more sounding reference signals, or a combination thereof; and
receiving, in response to transmitting the one or more signals, an indication of the one or more timing advances.

18. The method of claim 15, wherein the one or more signals comprise a random access message of the initial access procedure that indicates the at least the subset of the plurality of TRPs in response to receiving the plurality of SSBs, the method further comprising:
receiving, in response to transmitting the one or more signals, a random access response of the initial access procedure that indicates the one or more timing advances.

19. The method of claim 15, wherein the one or more signals comprises a first random access message of a first random access procedure corresponding to a first TRP and a second random access message of a second random access procedure corresponding to a second TRP of the plurality of TRPs, the method further comprising:
receiving a random access response that indicates to communicate with the network via the subset of the plurality of TRPs in accordance with the one or more timing advances, the one or more timing advances based at least in part on transmitting the first random access message and the second random access message of the second random access procedure.

20. A non-transitory computer-readable medium storing code for wireless communications at a user equipment (UE), the code comprising instructions executable by one or more processors to:
receive a plurality of synchronization signal blocks (SSBs) each corresponding to a respective transmission and reception point (TRP) of a plurality of TRPs of a network;
transmit, in an initial access procedure in accordance with receiving the plurality of SSBs, one or more signals indicative of one or more timing advances, each of the one or more timing advances corresponding to a TRP of at least a subset of the plurality of TRPs; and
communicate with the network via the subset of the plurality of TRPs in accordance with the timing advances corresponding to the subset of the plurality of TRPs.
